(19) United States
(12) Patent Application Publication
(10) Pub. No.: US 2018/0336649 A1
(43) Pub. Date: Nov. 22, 2018

(54) Method for Selling Homes

(71) Applicant: Ray Sedighi, Downey, CA (US)

(72) Inventor: Ray Sedighi, Downey, CA (US)

(21) Appl. No.: 15/598,122

(22) Filed: May 17, 2017

(51) Int. Cl. G06Q 50/16; G06Q 30/08; G06Q 40/04; G06Q 30/02; G06Q 40/02

(52) U.S. Cl. CPC G06Q 50/16; G06Q 30/08; G06Q 40/025; G06Q 30/0277; G06Q 40/04

(57) ABSTRACT

A cost free method for selling a residential home. A standard real estate listing is provided through the Multiple Listing Service (MLS) for a period of time at no cost to the seller. Photos are taken and signs placed on the property. Advertisements are provided through standard advertising services. Sales are negotiated for the seller, escrow is opened monitored, and closed. The listing may be terminated by the seller at any time. The property is offered through an Internet based bidding process. The buyer pays as 3.5% fee if they are represented by an agent. If no outside agent is involved, the buyer pays a 2% fee.

### BACKGROUND OF THE INVENTION

The present invention relates to residential real estate sales and in particular to a method with no fees for a seller.

Real estate is often the most valuable asset of a family or individual. From time to time, due to changes in family, work, and health, home owners must sell their homes. Generally, there is a commission paid to a realtor representing the seller and to another realtor representing the buy, and the total commissions are typically about six percent of the selling price. When homes sell for $500,000 or more, these commissions are $30,000 or more. Such large costs are emotionally difficult for the seller to accept, and often cause a seller to resist selling their home even when events make the sale necessary. A need thus exists for a method for listing and selling a home which does not present large costs to the seller.

Further, the normal process of presenting an offer with a check through an agent representing the buyer, increases expenses, adding time and to the agent's fee. A need exists to reduce this cost and additional steps in the buying process.

### BRIEF SUMMARY OF THE INVENTION

The present invention addresses the above and other needs by providing a cost free method for selling a residential home. A standard real estate listing is provided through the Multiple Listing Service (MLS) for a period of time at no cost to the seller. Photos are taken and signs placed on the property. Advertisements are provided through standard advertising services. Sales are negotiated for the seller, escrow is opened monitored, and closed. The listing may be terminated by the seller at any time before accepting any offer. The property is offered through an Internet based bidding process. The buyer pays as 3.5% fee if they are represented by an agent. If no outside agent is involved, the buyer pays a 2% fee.

In accordance with one aspect of the invention, there is provided a real estate selling service offering no cost selling to home owners with buyers bidding through a website. The website provides detailed information of the property. The website instantly forwards offers to the seller through the broker and allows the seller to compare offers. The website further offers pre-qualifying and provides buyer's qualifying information to the seller allowing the seller to make better decisions regarding accepting an offer.

In accordance with another aspect of the invention, there is provided a method for selling residential real estate with no fees charged to the seller. The method includes collecting description of a residence, photographing the residence and storing the photographs as digital images in memory, posting the residence on bidding website with no fees charged to the seller, continuing posting the residence on the web site until a seller cancels the listing, a time expires, or the residence is sold. Receiving a buyer's bids on residence through bidding website, forwarding buyer's bids to seller and receiving the seller's response. If at least one bid is accepted, entering escrow. If escrow is successful, completing the sale and collecting fees from the buyer with no fees charged to the seller, if escrow is not successful, returning to receiving bids. If no bids were accepted, returning to receiving bids.

### BRIEF DESCRIPTION OF THE SEVERAL VIEWS OF THE DRAWING

The above and other aspects, features and advantages of the present invention will be more apparent from the following more particular description thereof, presented in conjunction with the following drawings wherein:

FIG. 1 is a method for advertising real estate for sale with no seller's fees, according to the present invention

FIG. 2 is a method for receiving and processing bids for the real estate with no seller's fees, according to the present invention.

Corresponding reference characters indicate corresponding components throughout the several views of the drawings.

### DETAILED DESCRIPTION OF THE INVENTION

The following description is of the best mode presently contemplated for carrying out the invention. This description is not to be taken in a limiting sense, but is made merely for the purpose of describing one or more preferred embodiments of the invention. The scope of the invention should be determined with reference to the claims.

Where the terms “about” or “generally” are associated with an element of the invention, it is intended to describe a feature's appearance to the human eye or human perception, and not a precise measurement.

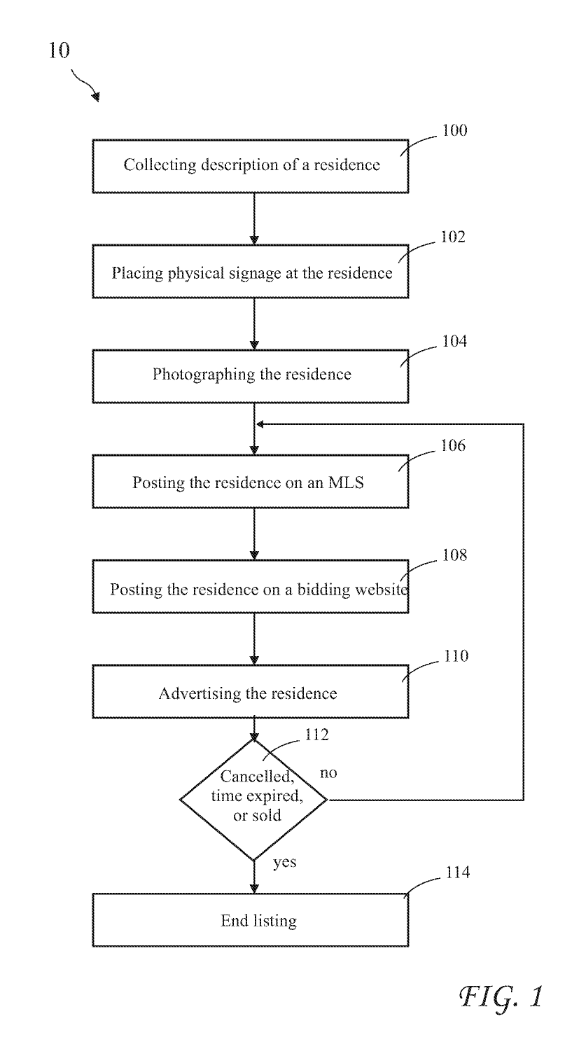

A method 10 for advertising real estate for sale with no seller's fees, is shown in FIG. 1. The method 10 includes collecting description of a residence at step 100, placing physical signage at the residence at step 102, photographing the residence at step 104, posting residence on MLS at step 106, posting the residence on bidding website at step 108, advertising residence at step 110, if the seller cancels the listing, a time period (for example 90 days) has expired, or the residence has been sold, at step 112, ending the listing at step 114, otherwise continuing the listing. Photographing the residence at step 104 preferably includes storing digital images of the residence in memory and uploading the digital images to the MLS and to the bidding website.

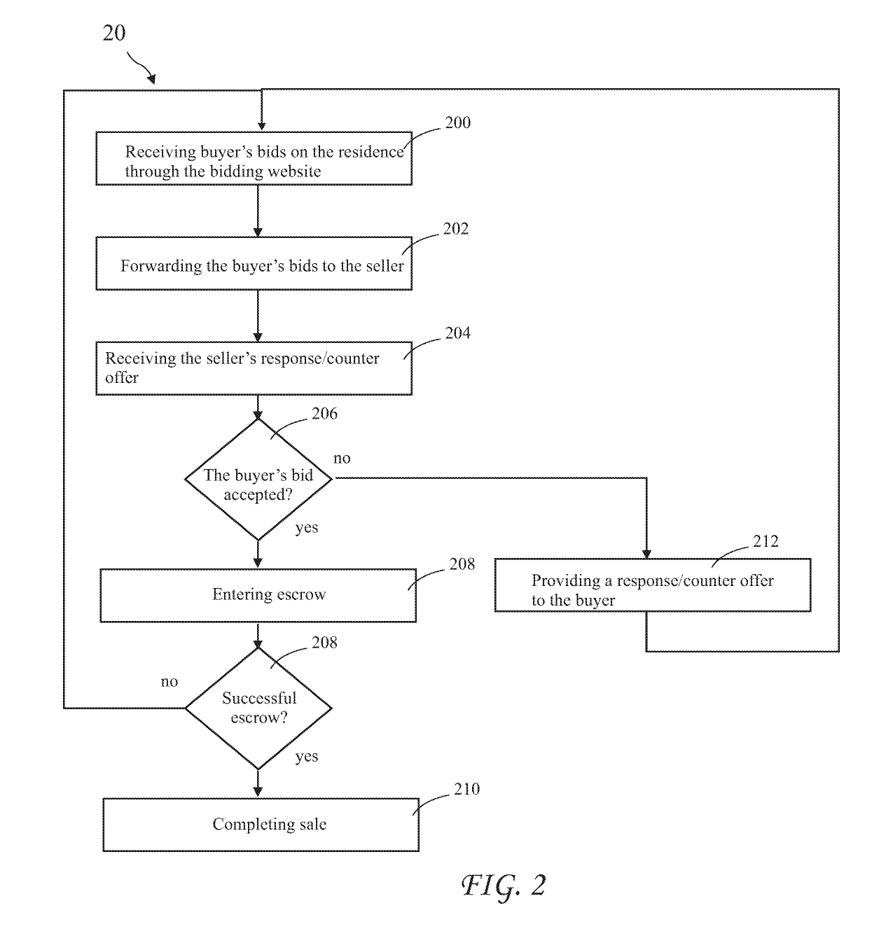

A method 20 for receiving and processing bids for the real estate with no seller's fees is shown in FIG. 2. The method 20 includes receiving buyer's bids on the residence through the bidding website at step 200, forwarding the buyer's bids to the seller at step 202, receiving the seller's response/counter offer at step 204, if the buyer's bid is accepted at step 206, entering escrow at step 208 and if the escrow is successful, completing the sale at step 210. If escrow is entered but not successful at step 208 returning to receiving buyer's bids at 200. If the buyers bid was not accepted at 206, providing a response/counter offer to the buyer at step 212 and returning to receiving buyer's bids at 200. Receiving the buyer's bid at step 200 may further include the buyer agreeing to pay a first fee if the buyer is represented by an agent, and agreeing to pay a lower second fee if the buyer is not represented by an agent. The first fee is preferably about 3.5 percent and the second fee is preferably about 2 percent.

While the invention herein disclosed has been described by means of specific embodiments and applications thereof, numerous modifications and variations could be made thereto by those skilled in the art without departing from the scope of the invention set forth in the claims.

I claim:

1. A method for selling residential real estate with no fees charged to the seller, comprising:
collecting a description of a residence;
photographing the residence and storing the photographs as digital images in memory;
posting the residence on a bidding website with no fees charged to the seller;
continuing posting the residence on the website until at least one condition is met selected from the group consisting of:
a seller cancels the listing;
a time expires; and
the residence is sold;
receiving buyer's bids on residence through bidding website;
forwarding the buyer's bids to the seller;
receiving the seller's response;
if at least one bid is accepted, performing:
entering escrow;
if escrow is successful, completing the sale and collecting fees from the buyer with no fees charged to the seller;
if escrow is not successful, returning to receiving bids; and
if no bids are accepted, returning to receiving bids.

2. The method of claim 1, further including listing the residence on a Multiple Listing Service (MLS).

3. The method of claim 1, further including placing physical signage at the residence.

4. The method of claim 1, further including advertising the residence.

5. The method of claim 1, further including offering the buyer pre-qualification on the bidding website.

6. The method of claim 5, further including providing the buyer pre-qualification information to the seller when bids are provided to the seller.

7. The method of claim 1, wherein receiving bids on the residence through the bidding website includes the buyer agreeing to paying fees if the sale is completed.

8. The method of claim 7, wherein collecting the fees from the buyer comprises the buyer paying a first fee if the buyer is represented by a buyer's agent and paying a lower second fee if the buyer is not represented by the buyer's agent.

9. The method of claim 8, wherein the first fee if the buyer is represented by the buyer's agent is 3.5 percent and the second fee if the buyer is not represented by the buyer's agent is 2 percent.

10. A method for selling residential real estate with no fees charged to the seller, comprising:
collecting description of a residence;
photographing the residence and storing the photographs as digital images in memory;
placing physical signage at the residence;
listing the residence on the through a Multiple Listing Service (MLS);
advertising the residence;
posting the residence on a bidding website;
offering a buyer pre-qualification on the bidding website;
continuing posting the residence on the web site until at least one condition is met selected from the group consisting of:
a seller cancels the listing;
a time expires; and
the residence is sold;
receiving the buyer's bids on the residence through bidding website;
forwarding the buyer's bids to seller;
providing buyer re-qualification information to the seller when the buyer's bids are forwarded to the seller;
receiving the seller's response;
if at least one bid is accepted, performing:
entering escrow;
if escrow is successful, completing the sale and collecting fees from the buyer with no fees charged to the seller, the buyers fees comprising a first fee of 3.5 percent if the buyer is represented by a buyer's agent or a second fee of 2 percent if the buyer is not represented by the buyer's agent;
if escrow is not successful, returning to receiving bids; and
if no bids are accepted, returning to receiving bids.
